(19) United States
(12) Patent Application Publication
(10) Pub. No.: US 2021/0396625 A1
(43) Pub. Date: Dec. 23, 2021

(54) BUILDING STRAIN MONITORING SYSTEM

(71) Applicants: Malcolm Elias Masri, Dublin, OH (US); Sai Rishik Lingam, Dublin, OH (US); Arwen Huanyan Zhang, Dublin, OH (US); Anya Xinlei Zhang, Dublin, OH (US); Maxwell Massahide Imamura, Dublin, OH (US); Sathvik Reddy Allipuram, Dublin, OH (US); Kunaal Srinivas Gudavalli, Dublin, OH (US); Farid E. Masri, Dublin, OH (US)

(72) Inventors: Malcolm Elias Masri, Dublin, OH (US); Sai Rishik Lingam, Dublin, OH (US); Arwen Huanyan Zhang, Dublin, OH (US); Anya Xinlei Zhang, Dublin, OH (US); Maxwell Massahide Imamura, Dublin, OH (US); Sathvik Reddy Allipuram, Dublin, OH (US); Kunaal Srinivas Gudavalli, Dublin, OH (US); Farid E. Masri, Dublin, OH (US)

(21) Appl. No.: 17/356,512

(22) Filed: Jun. 24, 2021

Related U.S. Application Data
(60) Provisional application No. 63/042,678, filed on Jun. 23, 2020.

(51) Int. Cl. G01M 5/00; G08B 7/06; G01L 1/22; G08B 3/10; G08B 5/22; G08B 21/18; G08B 5/36

(52) U.S. Cl. CPC G01M 5/0058; G08B 7/06; G01L 1/2206; G08B 5/36; G08B 5/224; G08B 21/182; G08B 3/1033

(57) ABSTRACT

A method for monitoring at least one support structure in an above ground building, includes at least one strain gauge, wherein each of the strain gauges is attached to one of the support structures in the above ground building to detect the strain of the support structure at the area of attachment. An interrogator unit is connected to a gauge having a connection means providing access to the strain gauges for the interrogator unit, wherein the interrogator unit provides an output of strain values at each of the strain gauges. The embodiment also includes a monitoring system connected to the interrogator unit, wherein the monitoring system outputs an alarm signal when an evaluation of the strain value any of the strain gauges indicates a significant condition wherein the alarm signal in connected to the building control system to execute an action.

### RELATED APPLICATION(S)

This utility non-provisional patent application claims priority from provisional patent application No. 63/042,678, entitled “BUILDING STRAIN MONITORING SYSTEM”, filed 23 Jun. 2020.

### FEDERALLY SPONSORED RESEARCH OR DEVELOPMENT

Not Applicable.

### FIELD OF THE INVENTION

The strain in structural members such as roof trusses, beams, lateral bracing, columns and joists caused by external factors can be detected with a matrix of fiber optic strain sensors attached to said structural members. Our invention uses these sensors to monitor the strain on a beam in a building due to failure of the beam of excessive loading occurs. One common example monitors a roof to determine when rooftop snow and ice removal is required to reduce strain and when a roof collapse is imminent, saving costs and lives. Other examples include wind loads and items added to the building held up by the structural members.

### BACKGROUND OF THE INVENTION

Strain sensors have been used for many years in research of materials. They have been used in fan blades of wind turbines, some bridge structures and in mining for the measurement of strain on those materials and structures. However, strain sensors for detecting unsafe loads on above ground building structures have not used. The most common area where the load is highly variable in building after construction and in use is the roof due to snow, water and wind. However, there are also other areas of buildings such as floors, for instance, due to overcrowding, that may be subject to excessive loads. Some of those floors may be above the lowest level of the basement of the building. Currently, there are limited ways to accurately keep track of these loads and warn authorities that dangerous levels of loading that exist.

Flat roofs are commonly used on buildings such as box stores, warehouses, fulfillment centers and even schools. They are cheap, fast, and easy to construct, but they are susceptible to collapse under loads. There are several thousand such roof collapses in North America each year accounting for billions in insurance claims. These loads include but are not limited to: snow, rain, ice, and wind.

Other factors that affect the roofs integrity are installation and construction errors, along with other maintenance issues, such as corrosion. Because of this, flat roof building owners have to shovel snow and ice from their roof to prevent roof collapses. However, around 50% of roof shoveling is unneeded. Excessive shoveling damages the roof waterproofing membrane, and shoveling is both expensive and dangerous. The process is very laborious and is done by hand as heavy equipment causes more damage to a roof. Even with required plastic shovels, waterproofing membranes often get cut and repair and replacements costs are very high.

Currently, flat roof building owners have no reliable way to tell when and when not to shovel snow, remove ice, or any means to reliably detect water puddling (due to sudden heavy rain or snow melt). Instead, they take inaccurate guesses based on visual inspection of roofs or based on ground snow levels. Roof snow levels are usually different from ground snow levels, mainly due to airflow patterns over the building. Obstacles such as stairwells, HVAC equipment, solar panels, and parapet walls create wind eddy currents that swirl and create snow drifts on the roof surface. Even trucks parked next to a building change the airflow patterns over the roof. Snowdrifts concentrate loads on roofs and increase chances of roofs collapses. Some roofs have surface areas of several hundred thousand square feet, making visual estimation of snow levels across the entire roof very difficult. This issue is not limited to building roofs. Snow piles on top floors of multi-story garages have caused support beam to crack and fail in some instances.

Some owners use rooftop video cameras or drones to help monitor conditions. Some have used yardsticks, or pole mounted sonar transmitters that help detect when snow levels reach a certain point. Most owners send a person to the roof and have them manually measure the snow depth. However, due to high risk of falls, this practice is becoming less desirable. Snow depth measurement alone is not a good indicator of the load on the roof, as snow weight varies between 3 and 21 lbs/c.f. and ice can weigh up to 60 lbs/c.f. So owners sometimes resort to gathering samples of snow in pails to obtain the weight of snow.

Some owners have used light beams mounted inside the building to detect deflection of roof joists. When roof joists (trusses) sag in the middle, they disrupt the light beam and an alarm is triggered. A commercial version is covered under patents US5404132 and US5850185. Other optical methods to detect sag in beams are disclosed in the patent.

Beam deflection is usually at a maximum in the middle of the beam for uniform loads. As concentrated loads (point loads in engineering terms) move further from the center of the beams towards the fixed ends, the amount of deflection at the center continues to decrease until the deflection reaches zero when the load is directly over the fixed end. So, a dangerous point load from a snow drift near a parapet wall might not cause the beam to deflect enough at the center to interrupt the light beam, but yet might be enough to cause structural failure. Indeed, there are several examples of these types of accidents.

### BRIEF DESCRIPTION OF THE DRAWINGS:

FIG. 1 illustrates a cross section of steel beams.

FIG. 2 illustrates a typical truss with lateral bracing.

FIG. 3 illustrates the deflection of a truss under load.

FIG. 4 illustrates system of a single string of sensors, interrogator, monitoring system and building control for the invention.

FIG. 5 illustrates system of multiple strings of sensors, interrogator with an optical multiplexer, monitoring system and building control for the invention.

FIG. 6. illustrates the configuration of distributed sensor fiber/on multiple support members.

FIG. 7. illustrates the configuration of sensors on multiple trusses using FBG sensors.

### DETAILED DESCRIPTION OF FIGURES

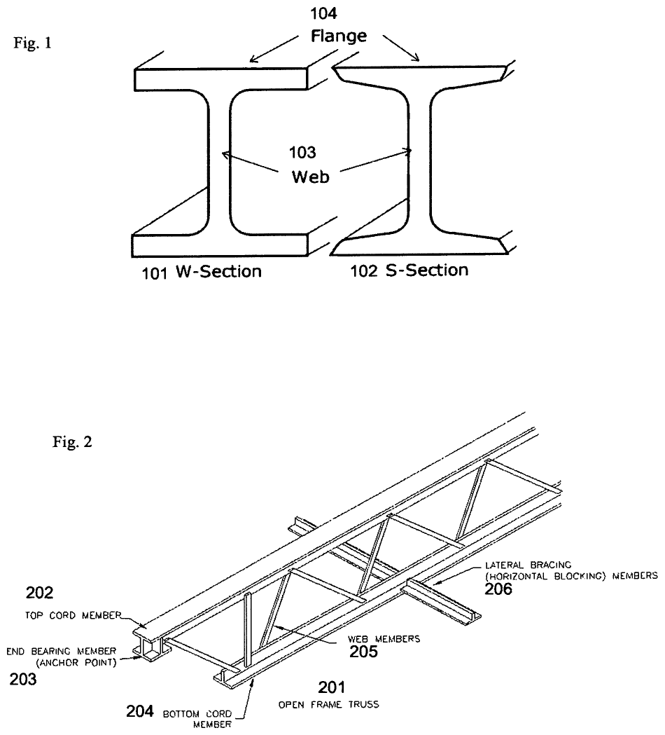

FIG. 1 illustrates a cross section of steel beams. Two types of beams are shown. The first, W-Section (101), has a flange (104) with square edges. The second, S-Section (102), has a flange (104) with angled edges. The sensors can be applied to the top, typically to measure compression, the bottom, typically to measure tension, or to the side to measure strain from lateral forces.

FIG. 2 illustrates a typical truss with lateral bracing. The truss (201) is made up of a top cord member (202), bottom cord member (204) and web members (205). The trusses are typically connected laterally with lateral bracing or horizontal blocking (206). The trusses are held up with an end bearing member (303) at each end of the truss. The end bearing member may be placed on a column (504), beam (504), another truss, or a wall (507).

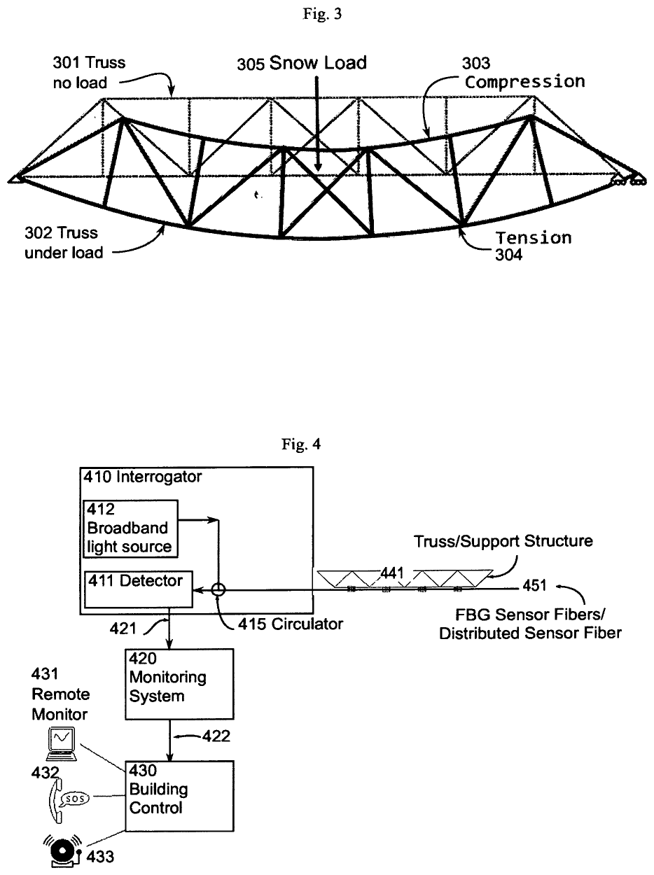

FIG. 3 illustrates the deflection of a truss under load. While this figure illustrates a truss, it can equally be applied to a steel or concrete beam. The truss (301) is shown with no load. A load such as a snow load (305) is applied to the truss (302) and causes the truss (302) to deflect. The amount shown is exaggerated to illustrate the point. Typical deflections are much less. The snow load (305) shown is a point load but it typically is a distributed load across the entire length of the truss (302). The top of the truss is compressed (303) representing a negative strain. The bottom of the truss is under tension (304) representing a positive strain.

FIG. 4 illustrates system of a single string of sensors, interrogator, monitoring system and building control for the invention. The truss or support structures (441) is being monitored by the FBG Sensor fibers or distributed sensor fiber (451). Most of the sensors (451) are attached to the support structures (441) as strain sensors. Some of the sensors (451) may not be connected to the support structure (441) are used as temperature sensors. Only one support structure (441) is shown, the other support structures can be associated with the string of sensors (451). At least one sensor is in each string of sensors (451).

The sensors (451) are connected to an interrogator (410) with fiber optics. The string of sensors (451) is connected directly to the circulator (415).

The broadband light source (412) is directed to the selected sensors (451) through the circulator (415) then the reflected light from the selected sensors (451) is returned through the optical multiplexer (413) and the circulator (415) to the detector (411) input. The broadband light source (412) and the detector (411) coordinate to obtain a reading from the sensors (451). The readings as raw measurements of strain and temperature are sent to the monitoring system (420) via connection (421). The monitoring system (420) uses the raw measurements of strain and temperature to generate calibrated measurements.

The monitoring system (420) determines whether the calibrated measurements are significant and provides alarms to the building control (430) via connection (422). The building control (430) provides an action based on the alert. There actions are shown, a remote monitor (431), a telephone call (432) and a bell (433). Another action can be an audiovisual output. The telephone call can be made with operation personnel for the building, owners of the building and to emergency services. The monitoring system may use the measurements of the temperature sensors to provide alarms based on temperature alone, for instance, to alert for a fire.

It should be noted that other preferred embodiments are possible using different sensing technologies to obtain the strain measurements on a building structure.

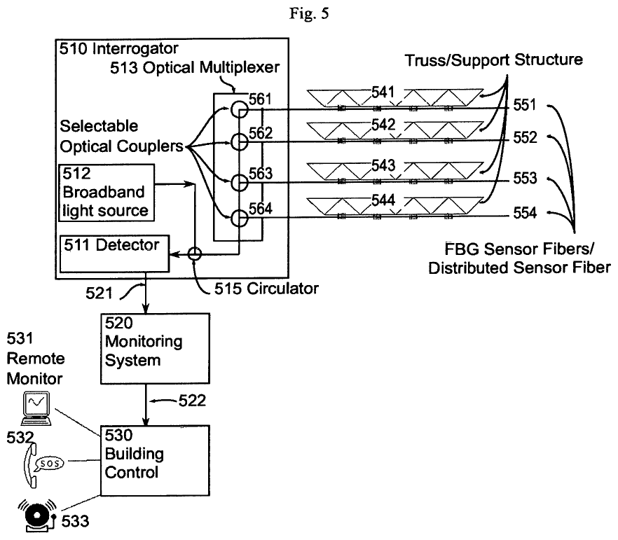

FIG. 5 illustrates system of multiple strings of sensors, interrogator with an optical multiplexer, monitoring system and building control for the invention. The multiple truss or support structures (541, 542, 543 and 544) are being monitored by the FBG Sensor fibers or distributed sensor fiber (551, 552, 553 and 554). Most of the sensors (551, 552, 553 and 554) are attached to the support structures (541, 542, 543 and 544) as strain sensors. Some of the sensors (551, 552, 553 and 554) may not be connected to the support structure (541, 542, 543 and 544) are used as temperature sensors. At least one sensor is in each string of sensors (541, 542, 543 and 544). However, the typical installation has multiple sensors in the string of sensors (551, 552, 553 and 554).

The strings of sensors (551, 552, 553 and 554) are connected to an interrogator (510) with fiber optics. Each of strings of sensors is coupled with one of the selectable optical couplers (561, 562, 563 and 564) in the optical multiplexer (513). Four strings of sensors and four selectable optical couplers are shown but any number can be used in a given implementation. One of the selectable optical couplers (561, 562, 563 and 564) is enabled at a time to couple the corresponding one of the strings of sensors (551, 552, 553 and 554) to the circulator (515).

The broadband light source (512) is individually directed to one of the strings of sensors (551, 552, 553 and 554) through the circulator (515) and the optical multiplexer (513) then the reflected light from said string of sensors (551, 552, 553 and 554) is returned through the optical multiplexer (513) and the circulator (515) to the detector (511) input. The broadband light source (512), optical multiplexer (513) and the detector (511) coordinate to obtain a reading from each of the individual sensors on the string of sensors (551, 552, 553 and 554). The raw measurements of strain and temperature are sent to the monitoring system (520) via connection (521). The monitoring system (520) uses the raw measurements of strain and temperature to generate calibrated measurements of strain.

The monitoring system (520) determines whether the calibrated measurements of strain are significant and provides alarms to the building control (530) via connection (522). Items 520, 522, 530, 531, 532 and 533 function identically to 420, 422, 430, 431, 432 and 433.

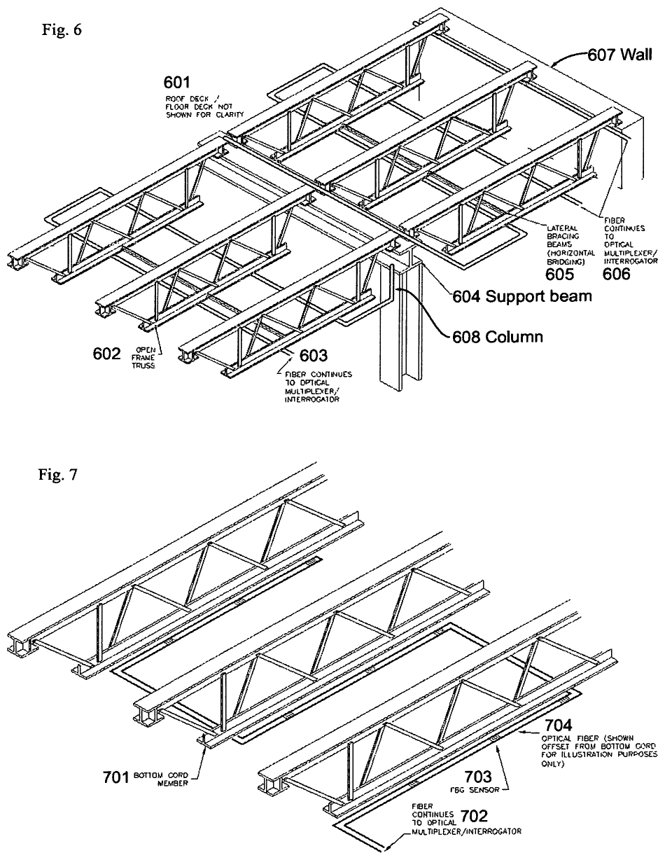

FIG. 6. illustrates the configuration of a distributed sensor fiber (603) along multiple lateral bracing (605), columns (608), trusses (602) and support beams (604). Each portion of the distributed sensor fiber (603) is attached along the entire length of the portion where strain is to be measured. The sensors can be attached to any of the support structures to measures strain. If another portion of the distributed sensor fiber is not attached to measure strain (mounted so it can move freely relative to the support structure) then it can be used for temperature measurements.

FIG. 7. illustrates the configuration of FBG sensors (441, 551, 552, 553 and 554) on multiple trusses. FIG. 6 illustrates attaching the FBG sensors (703) to the bottom cord (701) of a truss. The FBG sensors can be alternatively attached to other parts of the truss such as the top cord member (202), web members (205) and lateral bracing (206). The FBG sensors (703) are connected together using fiber optics (702). If one of the FBG sensors (703) is not attached to the bottom cord (701) to measure strain (it can be mounted so it can move freely relative to the bottom cord) then it can be used to measure temperature. As in FIG. 5, the FBG sensors can be attached to different types of support structures.

### TECHNICAL BACKGROUND

All structural components, such as roof joists, exhibit small amounts of deformation under normal loads. This deformation is called strain. It is the ratio of the amount of deformation to the original dimension (or dL/L) and is often expressed in parts per million or microstrains. Strain is positive if the material is stretched (tension) and is negative when the material is compressed (compression). Most structural materials, such as steel, exhibit elastic deformation up to a certain limit. Elastic deformation is when the material changes shape as force is applied, but returns to its original shape when force is removed. As the applied force continues to grow, a point is reached when the deformation becomes permanent. This is called plastic deformation. The transition point from elastic to plastic is called the yield point. This point defines the strength of the material and is typically expressed as the amount of force needed to reach this point (ksi -kilo pounds per square inch in imperial units). Continued application of force past the yield point results in additional plastic deformation until the material ultimately breaks. These concepts are well understood in engineering disciplines.

Roof joists are typically constructed with a top and bottom members called chords and a connecting member called web, to form a “I” configuration. The web can be solid, such as in an I—beam (FIG. 1), or often is open structure as in a truss and are called open web joist (or open truss—FIG. 2). Roof joists used in flat or semi flat roofs are typically of the open joist type. When a horizontal joist is subjected to loads above, it deflects downwards, creating tension in the bottom chord and compression in the top cord (FIG. 3). The web members can be subjected to either tension or compression, depending on the location and distribution of the load. Bridging members are typically horizontal angle iron connecting adjacent joists together. These help keep the joist in vertical orientation so that loads on roof remain in-line with the joist and prevent side buckling.

### SUMMARY OF INVENTION

The amount of strain in the roof joist can be measured using a strain gauge. Strain gauges respond to changes in length and come in a variety of configurations. The most common strain gauge uses a very thin metallic foil, forming a resistive element arranged in serpentine patterns on a flexible substrate, such that the resistance of the element changes when the element is stretched or compressed in a particular direction. This is called an electrical strain sensor, and its use is well known in the art. The sensor is adhered to the structure being monitored and subsequently connected to an electronic circuit to amplify the small electrical current changes that occur in the sensor when subjected to strain. The amplified signals can then be observed with a variety of monitoring devices, such as voltmeters, and data acquisition devices. Electrical strain gauges require between 2-4 connecting wires each, depending on the design and requirements.

A different type of strain sensor utilizes fiber optics to measure expansion and compression of materials. Some are also designed to measure bend directly. Fiber optic sensors mainly operate by detecting light scattering created in a fiber when subjected to strain. The most common strain sensor are FBG (Fiber Bragg Grating) sensors. A series of micron sized bands are etched along a length of fiber with nanometer spacing similar to the wavelength of light passing through the fiber. The etched portion of the fiber now becomes the strain sensor and length can vary between a few millimeters up to 1-meter with current technology, but expected to increase as techniques are refined. The longer sensor length offers a distributed sensing capability.

The fiber may be adhered to a structural member in a variety of methods well understood in the art. In a typical implementation, light from a broad spectrum source travels through the fiber. When the structural member is subjected to strain, the fiber is strained as well. This causes a portion of the light to be refracted and reflected back into the fiber. The strain causes the etched band spacing to change as well. This creates a wavelength change in the refracted light. This change in wavelength is then detected at the end of the fiber and the signal is interpreted as the amount of strain. The wavelength change is directly proportional to the amount of strain on the fiber. The detecting device is called an optical interrogator. By varying the spacing between the etched bands, sensors with different wavelengths can be created, so a number of different sensors can be placed on a single fiber, and each can be identified by its signature wavelength. This technique is called Wave Division Multiplexing (WDM). Other techniques are used such as measuring time of light travel between sensors. This technique is called Time Division Multiplexing (TDM). By combining the techniques in WDM/TDM systems, hundreds of sensors can be placed on a single fiber. Fiber length can be up to several kilometers. Multiple fibers can be multiplexed into a single optical interrogator, thus multiplying the sensor capacity of the system with minimal increase in hardware requirements. Contrast this to using electrical strain sensors, where each sensor requires its own wiring and its own signal conditioning circuit. Fiber optic sensors have a significant advantage over electrical sensors because they are immune to electromagnetic interference, and are easier to install in larger quantities. Incremental cost of adding more fiber sensors is drastically lower than with standard electrical sensors.

Other fiber optic sensor technologies use standard low cost telecommunication fibers. Strain changes the refractive index of the fiber at the strain location. These changes create a shift in light frequency that is then detected using an optical interferometer and subsequently translated to strain values. The advantage of these technologies is the ability to create truly distributed sensing, where the entire length of the fiber becomes a sensor. That means that the fiber attached to the chord of a beam can sense strain along the entire beam, making it easy to assess the structural health of the beam in a detailed matter. There are several techniques used to achieve distributed sensing along the length of the fiber. One such technique measures light scattering due to interaction of incident light and vibration or rotation of particles in the fiber as the fiber is strained due to external stress. By analyzing the information from the scattered light, strain values can be obtained. This method, called Raman scattering has an advantage of being less sensitive to temperature changes and more sensitive to strain. It can also be combined to FPG sensors on the same fiber to create a high resolution sensing system. Another detection method utilizes Rayleigh scattering of light depends on polarization shifting of particles as the fiber is subjected to strain. Rayleigh light scattering techniques provide very high resolution and ability to detect static and dynamic strains and makes this suitable for monitoring existing structures, as some structures are already under loads. Another technique used in distributed sensing detects light scattering due to interaction of incident light with particles in the fiber due to small variations in the fiber structure along the length of the fiber as the fiber is strained. This method (BOTDR—Brillouin optical time domain reflectometer) relies on Brillouin scattering due to Brillouin frequency shift proportional to applied strain. This method works well for detecting dynamic strain as providing good resolution, though not as good as Rayleigh or Raman scattering methods.

Strain sensors would typically be installed along the bottom joist chord and sense tension (compression in case of uplift). It can be utilized just as well on the top chord. Additional sensing locations on joist web elements can help detect joist manufacturing defects and excessive loading. Sensing excessive strain on joist anchor points can help detect excessive shear loads that can collapse structures. Anchor point is the location were a roof joins a building structure, such as building wall or a main support beam. Sensors can be added to bridging members to help detect excessive lateral loads on joists. Bridging members connect between roof support joists, perpendicular to direction of joists. This prevents lateral movement of joists which leads to buckling and collapse. Sensors connected to anchor points between main support beams and vertical load bearing columns and walls also help detect excessive loads and joint failures due to excessive loads or construction defects.

### DESCRIPTION OF THE INVENTION

Disclosed herein is a system that can detect the strain on roof joists and support members and provide information about the location and size of the loads that cause this strain. It can be used to determine when snow or ice removal is necessary to prevent a collapse, or help determine the location of excessive water puddles or construction (or corrosion) errors causing excessive joist loading, and if a roof collapse is imminent and evacuation is required.

A preferred method uses fiber optic strain and temperature sensors adhered to roof joists and other roof supporting members to detect snow, ice, and other loads on roofs. Loads on the roof create stress forces in joists. The stress creates minute deformation (strain) in the joist members. This change is detected at the end of the fiber with an optical interrogator unit (FIG. 4). Calculations are then performed either by the interrogator unit, or preferably using a connected computing device with a software that compares the values of the sensors to a preset strain value that designates a danger level. The set value can be determined by a structural engineer or obtained from roof design data. Multiple values can be used to set varying levels of roof loading, such as to designate when roof shoveling is needed, or when shoveling can be postponed, or when a dangerous condition is imminent. The system continuously monitors the sensor values, allowing the building owner to view the amount and location of loads at any time. The system sends a message to the owner when the roof needs to be shoveled and sounds an alarm if a roof collapse is imminent. The system can be connected to an automated building control system. This allows convenient monitoring of all building systems at once. It can also allow the system to shut off gas and electric supplies if a roof collapse is imminent to help reduce chances of fire. Systems can also be connected to an internet gateway or telephone system to achieve remote monitoring and alarm notification (FIG. 4).

FIG. 5 illustrates an optical fiber anchored to roof joists with discrete sensors attached to the bottom chord of the joists. The fiber is routed transverse to the joists. The sensor portion of the fiber would be oriented in the direction that provides maximum sensitivity to strain changes. Figure-6 shows another method for routing the sensing fiber in-line with the joists.

This system can be setup with a quasi-distributed sensor matrix or use completely distributed fibers. For a quasi-distributed system using discrete sensors, a number of sensors are attached to each beam. This number can vary between 1 and multiple sensors, as needed. Increasing the number of sensors increases the resolution of the system and allows for better pinpoint location of point loads and defects. Loads can also be located mathematically between sensing points, by using ratios of strain on surrounding sensors. This technique typically requires multiple number of sensors along each joist.

Currently, the only method to achieve a truly distributed measurement system is by using fiber optic sensors. In a distributed system, fiber optic sensors detect loads at any point spanning the length of a roof joist. Brillouin, Raman, or Rayleigh scattering strain sensors are capable of precise location of the loads as well as very long sensing length, while FBG sensors are still limited to discrete or quasi distributed sensing over much shorter spans.

Sensors can be mounted on every roof joist, but in most instances, periodic installation on roof joists can be utilized. For example, sensors can be mounted on every other joist or every other second joist, etc. These factors can vary based on the age of the roof and underlying structure, the type of the roof design, and local weather conditions that can contribute to the risk. The systems can be easily customized to suit the application.

In order to compensate for temperature effects on strain sensors, an auxiliary set of fiber optic sensors may be mounted to roof beams such that they are not subjected to mechanical strain. These auxiliary temperature sensors measure how much strain is caused by temperature changes only. The primary set of fiber optic sensors attached to the roof beams measure strain caused by both roof loads and temperature. The temperature sensors are placed on the same fiber in series with the strain measuring sensors. Another technique places the temperature sensors on a separate fiber connected to the same optical multiplexer and interrogator unit. Another method utilizes electrical and electronic temperature sensors connected to the monitoring system. The system can then subtract the temperature strain value measured by the auxiliary sensors from the combined roof and temperature strain value measured by the primary sensors, leaving just the roof load strain value. Temperature sensors can be deployed adjacent to each strain sensor, or adjacent to a select few sensors. The latter method is often used in structural health monitoring as temperatures are typically fairly consistent across the application.

The temperature sensors can serve a secondary function for the purposes of detecting sudden changes in temperature, such increases due to fire inside or on top of the building structure, or due to breach in the roof structure.

The sensors are attached to the roof joist and trusses using a variety of methods well understood in the art, such as (but not limited to) tack welding, polyimide tape patch, mechanical bonding (fasteners or rivets), or epoxy bonding. Sometimes, fiber strain sensors are mounted first onto mechanical devices, which are in turn mounted to the beam of interest, such that when the devices are strained by external factor, such as a beam bending, said devices magnify the amount of strain seen by the fiber. Said devices are called mechanical multipliers and are common in the art. To ensure that the fiber is not damaged in areas where contact with the fiber can be an issue, a conduit or mechanical cover can be added to surround the fiber. It is contemplated to integrate the strain sensors to the joists during manufacture of the joists.

Measuring strain on roof joists and support members directly offers several advantages over other methods. As discussed earlier, visual methods including measuring snow depth can be highly inaccurate. Weighing samples of snow or ice improves accuracy in determining dangerous conditions, but varying snow height and snow drifts are still a problem, especially on very large roofs where snow can vary drastically and is easily misjudged. Measuring joist deflection is an indirect method for estimating when a joist is subjected to excessive loads. Deflection can vary greatly, depending on the joist design, span, and materials used, as well as whether the roof deck is fastened to the joist or not and how far apart the fasteners are. Building design codes offer guidelines for setting joist deflection, but these are based on practical limits, either for aesthetic reasons, such as to reduce visible sag of light fixtures and ceiling panels, or to prevent cracking in drywall, or swaying of fixtures.

A preferred embodiment for monitoring at least one support structure in an above ground building, includes at least one strain gauge, wherein each of the strain gauges is attached to one of the support structures in the above ground building to detect the strain of the support structure at the area of attachment. An interrogator unit is connected to a gauge having a connection means providing access to the strain gauges for the interrogator unit, wherein the interrogator unit provides an output of strain values at each of the strain gauges. The embodiment also includes a monitoring system connected to the interrogator unit, wherein the monitoring system outputs an alarm signal when an evaluation of the strain value any of the strain gauges indicates a significant condition wherein the alarm signal in connected to the building control system to execute an action.

The support structure can be a beam, an I-beam, anchor point, a truss, lateral bracing, web member, bottom cord member, top cord member, and end bearing member.

The strain gauge can be an electrical strain gauge, wherein the gauge connection means between the electrical strain gauge and the interrogator unit uses wires.

In an alternative embodiment, the strain gauge can be an optical strain gauge, wherein the optical strain gauge is a Fiber Bragg Grating optical strain gauge attached to said at least one of the support structures wherein the strain is measured at the strain gauge.

In an alternative embodiment, the strain gauge is a portion of a continuous fiber optic cable attached to said at least one support structures wherein the strain is measured anywhere along the portion of a continuous fiber optic cable. The method of interrogating the continuous fiber optic cable is one of: FPG and Raman combined scattering, Raman scattering, Rayleigh scattering, and BOTDR scattering (Brillouin optical time domain reflectometer).The embodiment uses fiber optic cables to connect the optical strain gauges. The embodiment also comprises an optical multiplexer wherein the multiple strings of optical strain gauges are coupled to one of a plurality of fiber optic cables and wherein the plurality of fiber optic cables are coupled to the optical multiplexer. The optical multiplexer couples one of the multiple fiber optic cables to a single fiber optic cable, and the single fiber optic cable is coupled to the interrogator.

An alternative embodiment connects the optical strain gauges in a single string of optical strain gauges using fiber optics. The single string is connected to the interrogator unit using fiber optics.

An alternative embodiment provides for at least two of the plurality of strain gauges are coupled together using fiber optics as a string of strain gauges, wherein one of the ends of the string of strain gauges is coupled to one of: the interrogator. and one of a plurality of inputs to an optical multiplexor and wherein the output of the optical multiplexor is connected to the interrogator. One of the plurality of inputs to the optical multiplexor is selected to be coupled to the output of said optical multiplexor.

The support structures of the above ground building support at least one of: a roof, a floor, a stadium seating support, a porch, a slab with a tank for water, a slab with a tank for a fluid, a slab with storage area for materials, a slab for equipment, and a cantilevered slab.

The embodiment wherein the significant condition is determined by comparing the strain values to a preset strain based on the design of the support structure. Alternatively, the significant condition is determined by analyzing past values of strain to determine the significant situation. In a further alternative, the significant condition is determined by experimentation by loading the support structure and measuring the strain under load to determine the preset a level of strain for a significant condition. In a further alternative, the significant condition is determined by manually setting the level of strain for a significant condition.

In the embodiment each of the strain gauges have a unique identifier and the identifiers of the strain gauges causing the alarm signal are communicated to the building control system. The action executed by the building control system provides an indication of the unique identifiers causing the alarm signal. The building control system provides at least one the actions: sounds an audible signal, computer generated voice on a loudspeaker, turns on a warning light, turns off gas lines to the above ground building, turns off electrical power to the above ground building, communication of strain status to other external systems, display the alarm, call a person, text a person, email a person, alert fire department and alert police. The action denotes at least one of: data of the strain values, safe conditions, unsafe conditions, maintenance needed, and an emergency.

The significant condition for at least one of the strain gauges is determined differently than any other of the strain gauges.

The strain gauges can attached the same support structure or a plurality of support structures.

In alternative embodiment at least one temperature sensor is available wherein a temperature connection means for coupling the plurality of temperature sensors to the monitoring system to provide temperature values at locations near at least some of the strain gauges, and wherein the monitoring system uses the temperature values to provide more accurate strain values. The plurality of temperature sensors can be strain gauges that are not attached to a support structure, and wherein the temperature connection means uses the gauge connection means. Alternatively said temperature sensor is an unattached portion of a continuous fiber optic cable that is not attached to at least one of said one of the support structures.

An alternative embodiment for monitoring strain in an above ground building comprises at least one support structure in the above ground building, at least one fiber optic strain gauge, wherein each of the fiber optic strain gauges is attached to one of said at least one support structure in the above ground building to detect the strain of the support structure at the area of attachment. The embodiment includes an interrogator unit and a gauge connection means to couple the fiber optic strain gauges to the interrogator unit. The interrogator unit provides an output of strain values at each of the strain gauges.

The gauge connection means couples each of the fiber optic strain gauges to the interrogator unit by at least one of the following:

coupling said fiber optic strain gauge to the interrogator unit using fiber optics,

coupling said fiber optic strain gauge to one of a plurality of inputs to an optical multiplexer using fiber optics and coupling the output of the optical multiplexer to the interrogator using fiber optics,

coupling at least two of the fiber optic strain gauges to each other in a string using fiber optics and coupling one of the at least two of the fiber optic strain gauges at the end of the string to the interrogator, and

coupling at least two of the fiber optic strain gauges to each other in a string using fiber optics and coupling one of the at least two of the fiber optic strain gauges at the end of the string to one of a plurality of inputs to an optical multiplexer and coupling the output of the optical multiplexer to the interrogator using fiber optics.

A monitoring system is connected to the interrogator unit, wherein the monitoring system outputs an alarm signal when an evaluation of the strain value any of the strain gauges indicates a significant condition. The alarm signal is connected to the building control system to execute an action. The building control system provides at least one the actions: sounds an audible signal, computer generated voice on a loudspeaker, turns on a warning light, turns off gas lines to the above ground building, turns off electrical power to the above ground building, communication of strain status to other external systems, display the alarm, call a person, text a person, email a person, alert fire department, and alert police.

An alternative embodiment further includes at least one temperature sensor, wherein a temperature connection means for coupling the plurality of temperature sensors to the monitoring system to provide temperature values at locations near at least some of the strain gauges, and wherein the monitoring system uses the temperature values to provide more accurate strain values.

### ADVANTAGES OF THE CURRENT INVENTION

Existing systems use indirect methods to determine if loading is excessive on the roof joists and support members. It is well known that a joist would fail if the amount of strain in the joist is excessive or has reached the yield point, so measuring strain directly in the joist is the best method to determine if there is excessive load or not, or if there is risk of collapse.

When needed, actual load values (such as snow, ice, and water weight) can be calculated from the measured strain using beam theory calculations. These calculations are well understood in the art.

Strain measurement has not previously been used, to Applicants' knowledge, to determine snow and ice loads and help owners decide when to engage in snow and ice removal. Fiber optic sensors in particular have been used on bridges, highways, and down-well applications, but have not been used, to Applicants' knowledge, to detect snow, ice, water and wind loads on roofs.

Existing methods fail to take into account uplift on the roof. Strain measurement can detect excessive uplift as well as downwards loading.

This invention eliminates the need for frequent roof inspections, thereby reducing the risk of fall for employees.

Unlike existing solutions, this invention can help pinpoint the location of excessive loads, allowing owners to limit remedial action only to areas most affected on the roof, thus saving the roof from damage caused by snow and ice removal and as well as extremely high labor costs involved in said operation. Reducing snow shoveling also reduces fall incidents.

Point loads can be accurately located either by using distributed fiber measurement systems, or via interpolation of discrete sensor data.

Unlike existing systems, strain measurements can be extended to roof joists and support beams and across beam anchor points help detect excessive loading and reduce risk of shear failure at beam connection points, a common failure point in resulting in roof collapses.

Our invention allows for measuring strain in bridging members to help detect excessive lateral loads on joists that can lead to joist collapse.

Unlike current roof deflection monitoring systems, our invention can be applied to most types and shapes of roof designs, including, flat, sloped, curved slope, or elliptical shaped, etc. It can be used on buildings with irregular shapes (other than typical square or rectangular roof lines). This makes it suitable for use on stadiums, malls, museums, etc. It can also be used on old or new construction.

In our invention, the system is immune to electromagnetic interference. Unlike systems that rely on light beam or ultrasound detection methods, it is also immune to interference from objects that might accidentally block the light or sound path, such as animals, insects, and birds. Those systems are also susceptible to interference from dust and smoke (in industrial settings).

In our inventions, the systems temperature sensors can be used to detect sudden changes in temperature due to fire or physical breach of the roof structure. Discrete FBG sensors and fiber optic cables which are not connected to the structure can act as temperature sensors because their dependency is only dependent on temperature and matches the dependency of temperature of sensors that are subject to strain.

What is claimed is:

1. A method for monitoring at least one support structure in an above ground building, the method comprising:
at least one strain gauge,
wherein each of the strain gauges is attached to one of the support structures in the above ground building to detect the strain of the support structure at the area of attachment;
an interrogator unit;
a gauge connection means providing access to the strain gauges for the interrogator unit,
wherein the interrogator unit provides an output of strain values at each of the strain gauges;
the method further comprises:
a monitoring system connected to the interrogator unit,
wherein the monitoring system outputs an alarm signal when an evaluation of the strain value any of the strain gauges indicates a significant condition;
wherein the alarm signal in connected to the building control system to execute an action.

2. The method as in claim 1,
wherein the support structure is at least one of:
a beam,
an I-beam,
anchor point,
a truss,
lateral bracing,
web member,
bottom cord member,
top cord member, and
end bearing member.

3. The method as in claim 1,
wherein the strain gauge is at least one of:
an electrical strain gauge wherein the gauge connection means between the electrical strain gauge and the interrogator unit uses wires,
a Fiber Bragg Grating optical strain gauge attached to said at least one of the support structures wherein the strain is measured at the strain gauge, and
a portion of a continuous fiber optic cable attached to said at least one support structures wherein the strain is measured anywhere along the portion of a continuous fiber optic cable using one of:
FPG and Raman scattering,
Raman scattering,
Rayleigh scattering, and BOTDR (Brillouin optical time domain reflectometer).

4. The method as in claim 1,
wherein the gauge connection means uses fiber optic cables;
the method further comprises:
an optical multiplexer,
wherein the strain gauges are coupled to one of a plurality of fiber optic cables,
wherein the plurality of fiber optic cables are coupled to the optical multiplexer,
wherein the optical multiplexer couples one of the multiple fiber optic cables to a single fiber optic cable, and
wherein the single fiber optic cable is coupled to the interrogator.

5. The method as in claim 4,
wherein at least two of the plurality of strain gauges are coupled together using fiber optics as a string of strain gauges,
wherein one of the ends of the string of strain gauges is coupled to one of
the interrogator. and
one of a plurality of inputs to an optical multiplexer and wherein the output of the optical multiplexor is connected to the interrogator.

6. The method as in claim 5,
wherein one of the plurality of inputs to the optical multiplexor is selected to be coupled to the output of said optical multiplexor.

7. The method as in claim 1,
wherein the support structures of the above ground building support at least one of:
a roof,
a floor,
a stadium seating support,
a porch,
a slab with a tank for water,
a slab with a tank for a fluid,
a slab with storage area for materials,
a slab for equipment, and
a cantilevered slab.

8. The method as in claim 1,
wherein the significant condition for each of the strain gauges is determined by at least one of:
comparing the strain values to a preset strain based on the design of the support structure,
analyzing past values of strain to determine the significant situation,
experimentation by loading the support structure and measuring the strain under load to determine a level of strain for a significant condition, and
manually setting the level of strain for a significant condition.

9. The method as in claim 1,
where each of the strain gauges have a unique identifier;
wherein the identifiers of the strain gauges causing the alarm signal are communicated to the building control system, and
wherein the action executed by the building control system provides an indication of the unique identifiers causing the alarm signal.

10. The method as in claim 1,
wherein the building control system provides at least one the actions:
sounds an audible signal,
computer generated voice on a loudspeaker,
turns on a warning light,
turns off gas lines to the above ground building,
turns off electrical power to the above ground building,
communication of strain status to other external systems,
display the alarm,
call a person,
text a person,
email a person,
alert fire department, and
alert police;
wherein the action denotes at least one of:
data of the strain values,
safe conditions,
unsafe conditions,
maintenance needed, and
an emergency.

11. The method as in claim 1, further comprising:
at least one temperature sensor,
wherein a temperature connection means for coupling said at least one temperature sensors to the monitoring system to provide temperature values at locations near at least some of the strain gauges, and
wherein the monitoring system uses the temperature values to provide more accurate strain values.

12. The method as in claim 3, further comprising:
at least one temperature sensor,
wherein the temperature sensor is a strain gauges that is not attached to a support structure, and
wherein the temperature connection means uses the gauge connection means, and
wherein the monitoring system uses the temperature values to provide more accurate strain values.

13. A system for monitoring at least one support structure in an above ground building, the system comprising:
at least one fiber optic strain gauge,
wherein each of the fiber optic strain gauges is attached to one of the support structures in the above ground building to detect that strain of the support structure at the area of attachment;
an interrogator unit;
wherein each of the fiber optic strain gauges is connected to the interrogator unit by at least one of the following:
a fiber optic cable between said fiber optic strain gauge and the interrogator unit,
a fiber optic cable connected to one of the fiber optic strain gauges and one of a plurality of inputs to an optical multiplexer and connecting the output of the optical multiplexer to the interrogator using another fiber optic cable,
at least two of the fiber optic strain gauges connected to each other in a string using fiber optics and one of the at least two of the fiber optic strain gauges at the end of the string is connected to the interrogator, and
at least two of the fiber optic strain gauges connected to each other in a string using fiber optics and one of the at least two of the fiber optic strain gauges at the end of the string is connected to one of a plurality of inputs to an optical multiplexer and connecting the output of the optical multiplexer to the interrogator using another fiber optic cable,;
wherein the interrogator unit provides an output of strain values at each of the strain gauges;
the method further comprises:
a monitoring system connected to the interrogator unit,
wherein the monitoring system outputs an alarm signal when an evaluation of the strain value any of the strain gauges indicates a significant condition;
wherein the alarm signal in connected to the building control system to execute an action.

14. The system as in claim 13,
wherein the optical strain gauge is a Fiber Bragg Grating optical strain gauge.

15. The system as in claim 13,
wherein the portion of a continuous fiber optic cable is measured anywhere along the portion of a continuous fiber optic cable using one of:
FPG and Raman scattering,
Raman scattering,
Rayleigh scattering, and
BOTDR (Brillouin optical time domain reflectometer).

16. The system as in claim 13, further comprising:
at least one temperature sensor,
wherein a temperature connection means for coupling said at least one temperature sensor to the monitoring system to provide temperature values at locations near at least some of the strain gauges, and
wherein the monitoring system uses the temperature values to provide more accurate strain values.

17. The system as in claim 13,
wherein the building control system provides at least one the actions:
sounds an audible signal,
computer generated voice on a loudspeaker,
turns on a warning light,
turns off gas lines to the above ground building,
turns off electrical power to the above ground building,
communication of strain status to other external systems,
display the alarm,
call a person,
text a person,
email a person,
alert fire department,
alert police; and
wherein the action denotes at least one of:
data of the strain values,
safe conditions,
unsafe conditions,
maintenance needed, and
an emergency.

18. A method for monitoring strain in an above ground building, the method comprising:
at least one support structure in the above ground building,
at least one fiber optic strain gauge,
wherein each of the fiber optic strain gauges is attached to one of said at least one support structure in the above ground building to detect the strain of the support structure at the area of attachment;
an interrogator unit;
a gauge connection means to couple the fiber optic strain gauges to the interrogator unit;
wherein the gauge connection means couples each of the fiber optic strain gauges to the interrogator unit by at least one of the following:
coupling said fiber optic strain gauge to the interrogator unit using fiber optics,
coupling said fiber optic strain gauge to one of a plurality of inputs to an optical multiplexer using fiber optics and coupling the output of the optical multiplexer to the interrogator using fiber optics,
coupling at least two of the fiber optic strain gauges to each other in a string using fiber optics and coupling one of the at least two of the fiber optic strain gauges at the end of the string to the interrogator, and
coupling at least two of the fiber optic strain gauges to each other in a string using fiber optics and coupling one of the at least two of the fiber optic strain gauges at the end of the string to one of a plurality of inputs to an optical multiplexer and coupling the output of the optical multiplexer to the interrogator using fiber optics;
wherein the interrogator unit provides an output of strain values at each of the strain gauges;
the method further comprises:
a monitoring system connected to the interrogator unit,
wherein the monitoring system outputs an alarm signal when an evaluation of the strain value any of the strain gauges indicates a significant condition;
wherein the alarm signal is connected to the building control system to execute an action.

19. The method as in claim 18,
wherein the strain gauge is at least one of:
a Fiber Bragg Grating optical strain gauge attached to said at least one of the support structures wherein the strain is measured at the strain gauge, and
a portion of a continuous fiber optic cable attached to said at least one support structures wherein the strain is measured anywhere along the portion of a continuous fiber optic cable using one of:
FPG and Raman scattering,
Raman scattering,
Rayleigh scattering, and
BOTDR (Brillouin optical time domain reflectometer).

20. The method as in claim 19, further comprising:
at least one temperature sensor,
wherein the temperature sensor is a strain gauges that is not attached to a support structure, and
wherein the temperature connection means uses the gauge connection means, and
wherein the monitoring system uses the temperature values to provide more accurate strain values.

21. The method as in claim 18,
wherein the building control system provides at least one the actions:
sounds an audible signal,
computer generated voice on a loudspeaker,
turns on a warning light,
turns off gas lines to the above ground building,
turns off electrical power to the above ground building,
communication of strain status to other external systems,
display the alarm,
call a person,
text a person,
email a person,
alert fire department, and
alert police.
